(19) United States
(12) Patent Application Publication
(10) Pub. No.: US 2026/0245352 A1
(43) Pub. Date: Aug. 20, 2026

(54) Method for generating a temporal sequence of evaluations of a situation and associated device

(71) Applicant: ORANGE, ISSY-LES-MOULINEAUX (FR)

(72) Inventors: Grégoire LEFEBVRE, CHATILLON CEDEX (FR); Julien CUMIN, CHATILLON CEDEX (FR); Juan VAZQUEZ RODRIGUEZ, CHATILLON CEDEX (FR)

(21) Appl. No.: 19/469,581

(22) PCT Filed: Mar. 20, 2024
(86) PCT No.: PCT/EP2024/057494

§ 371 Date: Sep. 26, 2025

(30) Foreign Application Priority Data
Apr. 5, 2023 (FR) FR2303404

(51) Int. Cl. G06V 10/82; G06N 3/08; G06V 10/72; G06V 10/764; G06V 10/774; G06V 20/40; G06V 20/52; G06V 40/10; G10L 25/63

(52) U.S. Cl. CPC G06V 10/82; G06N 3/08; G06V 10/72; G06V 10/764; G06V 10/774; G06V 20/40; G06V 20/52; G06V 40/10; G10L 25/63

(57) ABSTRACT

A method for generating a temporal sequence of assessments of a situation by a robust assessment model in the event of missing input data. The method includes: encoding, according to a multimodal Transformer encoding model, data resulting from a combination of positional encoding data, modality encoding data and temporal data, so as to obtain a plurality of temporal sequences of encoded multimodal representations; decoding to obtain a temporal sequence of assessments, the decoding including applying a self-attention model and implementing a cross-attention model.

### TECHNICAL FIELD

The present invention belongs to the general field of data analysis, and more particularly data processing to assess the extent to which a particular situation occurs. It more particularly relates to a method for generating a temporal sequence of assessments of a situation by a robust assessment model in the event of missing input data. It also relates to an electronic device configured to implement such a method.

The invention finds a particularly advantageous, although in no way limiting, application in the case where the model is used to assess the emotional state of a person or the evolution of the autonomy of a vulnerable person at home, for example with a view to determining a suitable measure to provide them as part of a remote assistance service. The invention also applies in the case where the model is used as part of a video surveillance service, for example with a view to determining a suitable protection measure for an environment equipped with sensors and actuators.

### PRIOR ART

In order to adapt to the continuous and ever-faster growth of the emitted data, various technologies are currently implemented and are the subject of research and improvement for optimal exploitation in the coming years.

Among these technologies, the multimodal learning is experiencing a growing success, as it offers significantly better performance than the methods that only consider a single modality. The objective of the multimodal learning is to build suitable models to process information from different modalities. The multimodal learning has in particular been successfully used for numerous applications, such as emotion recognition from multimodal data and event detection from multimedia data.

Early work in the field mainly considered the case where complete observations are provided as input to the model, whether during its training, validation, or exploitation. However, in practice, it is common for some modalities to be missing (e.g., for the input data to be affected by missing values at certain moments), which disrupts the learning of the model and, a fortiori, its exploitation. The absence, at least temporary, of data for at least one of the modalities classically expected as input to the model can be caused by various reasons, such as a communication problem between a sensor and an electronic device in which the aforementioned model is embedded, a problem in the data capture by one of the sensors, a displacement of a sensor in the environment causing the absence of data capture for a certain period, a movement of a person within their environment, etc.

Recently, different approaches have been proposed to deal with these missing modalities. A relatively classic solution is simply not to consider the input data (or samples) for which at least one of the modalities is missing. However, this solution has the drawback of reducing the time periods during which the model is trained or validated, which generates a significant decrease in the performance of the model.

Other methods called imputation methods aim to infer the missing data based on heuristics so as to be able to provide, as input to the model, input data whose modalities correspond to all those expected by this model. However, these imputation methods fail to restore the original distribution of the missing data, and therefore have the drawback of introducing statistical biases. Moreover, these imputation methods make the data processing and analysis more laborious.

Finally, other methods aim to process all the input data, even if some modalities are missing at certain moments. However, the performance of these methods is significantly reduced.

### DISCLOSURE OF THE INVENTION

The present invention aims to overcome all or part of the drawbacks of the prior art, in particular those set out above, by proposing a robust model to the missing data, both during the model training phase and during the model validation or exploitation phase.

More particularly, the present invention proposes a model that considers the complementarity of the information included in the input data through their different modalities, while also taking into account the previous assessments conducted by this model. In this way, even if at least one of the modalities expected by the model is not available, the latter will still be able to reliably assess a situation.

To this end, and according to a first aspect, the invention relates to a method for generating a temporal sequence of assessments (or predictions) of a situation by a robust assessment model (based on a neural network) in the event of missing input data, the method being implemented by an electronic device and comprising:
a step of obtaining a plurality of temporal sequences of input data resulting from sensors fitting an environment and/or a user, each sequence being associated with a modality, each element of a sequence being representative of a state, at one moment, of the modality associated with the sequence;
a step of encoding, according to a multimodal Transformer encoding model, data resulting from a combination, at each moment, of positional encoding data, modality encoding data and temporal data determined from the plurality of temporal sequences of input data, so as to obtain a plurality of temporal sequences of encoded multimodal representations;
a decoding step comprising a sub-step of applying an autoregressive self-attention model; and a sub-step of implementing a cross-attention model taking as input the plurality of temporal sequences of encoded multimodal representations, so as to generate a temporal sequence of intermediate assessments; and,
a step of converting the temporal sequence of intermediate assessments into the temporal sequence of assessments of a situation, said temporal sequence of assessments of a situation making it possible to control a triggering of a service adapted to the environment and/or to the user.

Within the meaning of the invention, the notion of modality is defined as a type of data captured by an electronic data capture device (i.e., a sensor), this type of data being expected as input to the assessment model according to the invention.

Thus, there is proposed a method for generating a temporal sequence of assessments of a situation, implemented by (at least one) neural network having an architecture consisting of an encoder and a decoder.

In a manner known per se, the encoder is composed of a set of layers of neurons, which process the data in order to construct representations called “encoded” representations in the sense that the dimensions of these representations are smaller than those of the input data (or samples). The decoder is also composed of layers of neurons which receive these representations and process them.

The use of a multimodal Transformer encoding model offers the advantage of combining the information resulting from different modalities. In general, those skilled in the art can refer to the following document for more details regarding the implementation of a Transformer encoding model: “Attention Is All You Need”, Ashish Vaswani & Al., Advances in Neural Information Processing Systems, volume 30, NIPS, 2017.

The remainder of the description more specifically relates to an assessment model having an architecture of the encoder-decoder type. The invention nevertheless remains applicable regardless of the nature of the considered neural network (convolution, perceptron, auto-encoder, recurrent, etc.).

Moreover, it is important to note that no limitation is attached to the type of training technique used to obtain the assessment model. Any technique implementing a learning algorithm (machine learning) and providing, as output, a representative assessment of the probability that a certain situation occurs considering observations (corresponding to input data), can be considered in the context of the invention (e.g., support vector machine, logistic regression, etc.). In other words, the assessment model is independent of the training method considered to train this model.

Furthermore, any training criterion known to those skilled in the art may be considered during the phase of training the assessment model, such as the least squares method or the cross-entropy minimization.

Moreover, no limitation is attached to the type or modality of the data processed by the assessment model. Similarly, no limitation is attached to the nature of the assessed situation (i.e., the nature of the situation(s) assessed is not a limiting factor of the invention).

Thus, in one particular exemplary implementation, the samples as input to the model include images (or features extracted from raw images), sound data (or features extracted from raw sound data) synchronized with the images, and physiological signals (or features extracted from physiological signals) also synchronized with the other input data.

According to another particular exemplary implementation, the inputs to the assessment model correspond to Internet resources (e.g., Web pages, tweets) or documents (audio, video, text, images), and the outputs to the model then correspond to the probability that an event will occur.

The use of an encoder comprising an autoregressive self-attention model is advantageous in that it constrains the assessment model to focus its attention on assessments previously carried out by this same model, for a situation assumed not evolving abruptly over time.

Finally, the use of a cross-attention model offers the advantage of constraining the assessment model to focus on the different representations at a certain moment (and consequently on the different modalities processed by the model), without temporal consideration.

Generally, it is considered that the steps of a method should not be interpreted as being related to a notion of temporal succession.

In particular modes of implementation, the generation method may further include one or more of the following features, taken separately or in all technically possible combinations.

In particular modes of implementation, the self-attention model is auto-regressive in that, at a current moment t, the self-attention model takes as input the intermediate assessments d_{t′=1 . . . t-1} previously determined by the assessment model from input data associated with past moments t′=1 . . . t−1.

In particular modes of implementation, the positional encoding data represent, for each temporal sequence of input data, the importance of the position of at least one of said elements in said sequence.

In particular modes of implementation, the modality encoding data represent the importance of a modality among the modalities of the plurality of temporal sequences of input data.

In particular modes of implementation, the generation method further comprises a step of determining the temporal data by application of at least one temporal convolutional network to the plurality of temporal sequences of input data.

In particular modes of implementation, a distinct temporal convolutional network is applied to each of the temporal sequences of input data.

In particular modes of implementation, the encoding step comprises a sub-step of filtering the data as input to the multimodal Transformer encoding model, so as to encode only the data comprised in a sliding time window relative to a current moment t.

This filtering sub-step is advantageous in that it constrains the assessment model to focus on recent information, which is more likely to influence the current situation than information associated with a distant past.

In particular modes of implementation, the temporal sequence of intermediate assessments comprises a plurality of multidimensional elements, and the conversion step comprises the application of a layer of a fully-connected neural network to the temporal sequence of intermediate assessments, so as to convert each multidimensional element into an value of assessment of a situation.

In particular modes of implementation, the method further comprises a step of determining positional encoding data, and of combining the intermediate assessments d_{t′=1 . . . t-1} previously determined by said assessment model from input data associated with moments t′=1 . . . t−1 with the determined positional encoding data, so as to obtain the intermediate assessments.

In particular modes of implementation, the cross-attention model takes as input M encoded representations

$${r}_{t}^{m = 1 … M}$$

associated with a current moment t, with M the number of temporal sequences of input data.

In particular modes of implementation, the generation method according to the invention further comprises:
a step of obtaining a plurality of temporal sequences of labeled learning data, each sequence being associated with a modality, each element of a sequence being representative of a state, at one moment, of the modality associated with the sequence;
a step of training the assessment model by minimizing a cost function defined such that [symbol] =1−CCC with CCC the concordance correlation coefficient.

In particular modes of implementation, the generation method according to the invention further comprises:
a step of iteratively generating assessments of the situation, by the assessment model, by processing input data of the same modality at each iteration, so as to classify the modalities according to their impact on the performance of the assessment model;
a step of retraining the assessment model, by taking as input learning data whose modality has an impact on the performance of the assessment model below a predetermined threshold.

In particular modes of implementation, the situation corresponds to an emotional state of a user.

In particular modes of implementation:
the sensors comprise a sound capture device and the associated temporal sequence of input data comprises elements representative of words issued by the user and/or of the user's prosody (sound modality); and/or
the sensors comprise a physiological sensor, and the associated temporal sequence of input data comprises elements

$$( {x}_{t}^{m} )$$

representative of the user's heart rate, respiratory rate and/or electric brain activity (physiological modality);
the sensors comprise an image capture device, and the associated temporal sequence of input data comprises elements representative of the user's facial and/or body expression (visual modality).

According to a second aspect, the invention relates to a computer program including instructions for implementing a generation method according to the invention, when said program is executed by a processor.

According to a third aspect, the invention relates to a computer-readable information or recording medium on which the computer program according to the invention is recorded.

The information or recording medium may be any entity or device capable of storing the program. For example, the medium may include a storage means such as a ROM for example a CD-ROM or a microelectronic circuit ROM, or a magnetic recording means for example a floppy disk or a hard disk.

On the other hand, the information or recording medium may be a transmissible medium such as an electrical or optical signal, which may be conveyed via an electrical or optical cable, by radio or by other means. The program according to the invention can be particularly downloaded from a network such as the Internet.

Alternatively, the information or recording medium can be an integrated circuit in which the program is incorporated (or embedded), the circuit being adapted to execute or to be used in the execution of the method in question.

According to a fourth aspect, the invention relates to an electronic device comprising an assessment model configured to determine a temporal sequence of assessments of a situation, the model being robust in the event of missing input data, the device comprising:
a module for obtaining a plurality of temporal sequences of input data resulting from sensors fitting an environment and/or a user, each sequence being associated with a modality, each element of a sequence being representative of a state, at one moment, of the modality associated with the sequence;
a multimodal Transformer encoder configured to encode data resulting from a combination, at each moment, of positional encoding data, modality encoding data and temporal data determined from the plurality of temporal sequences of input data, so as to obtain a plurality of temporal sequences of encoded multimodal representations;
a multimodal Transformer decoder configured to generate a temporal sequence of intermediate assessments, the multimodal decoder comprising an autoregressive multi-head self-attention sub-module; and a multi-head cross-attention sub-module taking as input the plurality of temporal sequences of encoded multimodal representations;
a module for converting the temporal sequence of intermediate assessments into the temporal sequence of assessments of a situation; and,
a module for controlling a triggering of a service adapted to the environment and/or to the user, according to the temporal sequence of assessments of a situation.

### BRIEF DESCRIPTION OF THE DRAWINGS

Other features and advantages of the present invention will emerge from the description given below, with reference to the appended drawings which illustrate one exemplary embodiment thereof without any limitation. In the figures:

FIG. 1A is an illustration of input data of an assessment model, during complete observations, and FIG. 1B is an illustration of input data of the assessment model, when data are missing.

FIG. 2 represents one example of an assessment system comprising an electronic device as proposed;

FIG. 3 schematically represents one example of the architecture of an encoder of the assessment model as proposed;

FIG. 4 schematically represents one example of the architecture of a decoder of the assessment model as proposed;

FIG. 5 schematically represents one example of the hardware architecture of an electronic assessment device as proposed;

FIG. 6 illustrates, in the form of a flowchart, the main steps of a general method for assessing a situation, according to one exemplary implementation of the invention.

### DESCRIPTION OF THE EMBODIMENTS

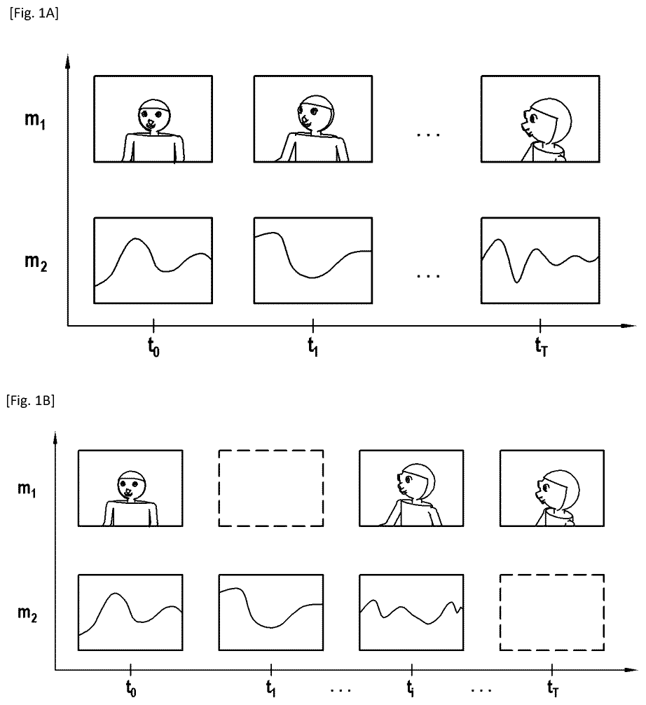

FIG. 1A is an illustration of input data of the assessment model, during complete observations, and FIG. 1B is an illustration of input data of the assessment model, when data are missing.

In this example, at each moment t₀, t₁, . . . t_{T}, the assessment model expects as input data samples (or elements) associated with two different modalities m₁ and m₂. The modality m₁ corresponds to the visual modality, and the input data associated with this modality correspond to features resulting from images of the face of a person. The modality m₂ corresponds to the modality called physiological modality, and the input data associated with this modality correspond to signals representative of the respiratory, heart and/or brain activity of this same person.

FIG. 1A illustrates a first example where all observations are complete, that is to say at each moment t₀, t₁, . . . t_{T}, the model processes as input samples including data associated with all the expected modalities.

FIG. 1B illustrates the case of missing data. More specifically, at the moment t₀, the model receives as input a sample corresponding to a complete observation since it includes data from both modalities m₁ and m₂. Then at the moment t₁, the model receives as input a sample including data from the modality m₂ only. At this moment t₁, the model therefore receives as input missing data. This situation is for example the consequence of a problem on the telecommunications network linking the capture device (e.g., the video camera) and the electronic device in which the assessment model is incorporated or embedded. At the moment tᵢ, the model again receives as input a sample corresponding to a complete observation. Then from the moment t_{T}, the model receives as input a sample including only data from the modality m₁.

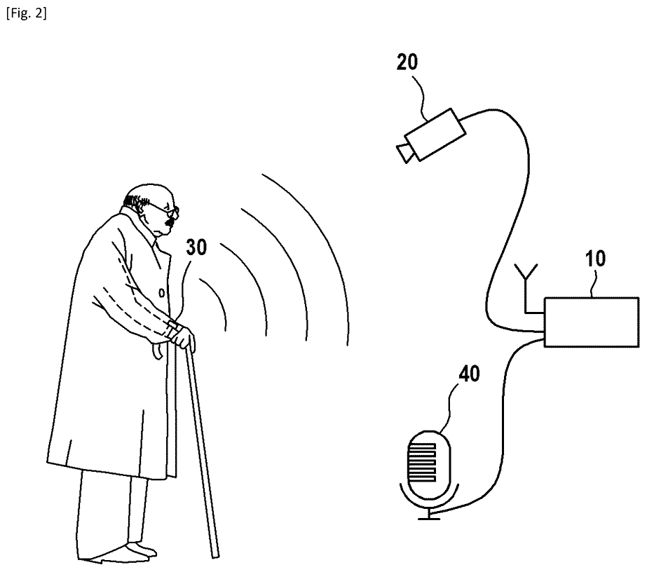

FIG. 2 represents one example of an assessment system comprising an electronic assessment device (10) as proposed. In this example, the electronic device (10) comprises an assessment model used to assess the emotional state of a vulnerable person (e.g., senior, person suffering from a disability, isolated person, etc.) at home, with a view to determining a suitable measure to provide them as part of a remote assistance service.

Such a system is particularly advantageous for home care to vulnerable people. Indeed, in this context, it appears necessary to have a better understanding of the emotions of these people, in order to provide a measure of autonomy and services adapted to the situation. This assessment of the emotional state is one of the strong indicators for assessing the good physical, social and moral health of vulnerable people by the medical profession through remote assistance services. Moreover, the emotions of a person can also reveal evolutions in their autonomy.

Also, the assessment model is configured to process raw data emitted by multimodal sensors fitting the environment (e.g., the home) in which a person is located, to determine an emotion score representative of an emotional state, then to trigger (or not) a certain service in order to influence this emotional state.

More specifically, in one particular exemplary implementation, the assessment model is configured to assess “negative” emotional situations of people from raw data resulting from sensors equipping a connected home and, in the event of assessment of such a situation, to trigger services encouraging these people to have “more positive” emotions. In general, those skilled in the art can refer to the following work for more details concerning the classification of emotions: “Emotions in Social Psychology”, Key Readings in Social Psychology, W. Gerrod Parrott, Psychology Press, 2000.

In one particular exemplary implementation, fifteen classes of emotions are defined: neutral (1), disgusted (2), panicked (3), anxious (4), angry (5), cold anger (6), desperate (7), sad (8), enthusiastic (9), happy (10), interested (11), bored (12), ashamed (13), proud (14), and contemptuous (15). The classes disgusted (2), panicked (3), anxious (4), angry (5), cold anger (6), desperate (7), sad (8), bored (12), and ashamed (13) can be considered negative, and the emotion classes enthusiastic (9), happy (10), and interested (11) can be considered positive.

The services that can be provided by the assessment model in response to an assessment of a situation (e.g., a negative emotion) are for example identified by links (e.g., web addresses) and stored in a correspondence table associating said services with predetermined values of respective scores.

If a threshold value is exceeded, at least one link to a corresponding digital service is accessed, then its activation is proposed to this person via a human-machine interface (not represented). As a variant, this service is automatically triggered.

As illustrated in FIG. 2, the assessment system comprises an electronic assessment device (10) configured to continuously obtain or receive a set of signals. Each signal in the set carries data from at least one modality.

These signals are generated by connected sensors, then transmitted to the electronic assessment device (10) through a telecommunications network (not represented). In this example, the connected sensors comprise an image sequence device (e.g., a video camera or a still camera) (10) configured to capture images of a person detected in a capture area of this camera.

A video recording of the person is then obtained (visual modality). This recording is analyzed by an analysis module (Video Content Analysis) of the video camera (20) or alternatively of the electronic assessment device (10), so as to collect different features relating to the face or facial expressions, to the different gestures or postures, to the movements of the person, to the ambient brightness, etc.

The electronic assessment device (10) is also configured to simultaneously receive other signals emitted by other sensors fitted to the environment or to the vulnerable person.

Thus, the assessment system of FIG. 2 further comprises an audio capture device (40) configured to collect an audio recording. The processing of this audio recording is for example implemented by said audio capture device (40), in order to extract therefrom signals representative of words issued by the person and/or the prosody of this person, of an ambient sound level, of an estimation of the position of the person, etc. Thus, in this example, the audio capture device (40) is configured to transmit a plurality of different signals (but associated with the same sound modality) to the electronic assessment device (10). As a variant, this processing on the raw signals is carried out by an analysis module of the electronic assessment device (10).

Finally, the assessment system of FIG. 2 comprises a physiological signal capture device (30) taking in this example the form of a smartwatch. This physiological signal capture device (30) is configured to capture and process signals representative of the heart rate, respiratory rate and/or electric brain activity of this person. As a variant, the processing on the different physiological signals (but associated with the same physiological modality) is implemented by an analysis module of the electronic assessment device (20).

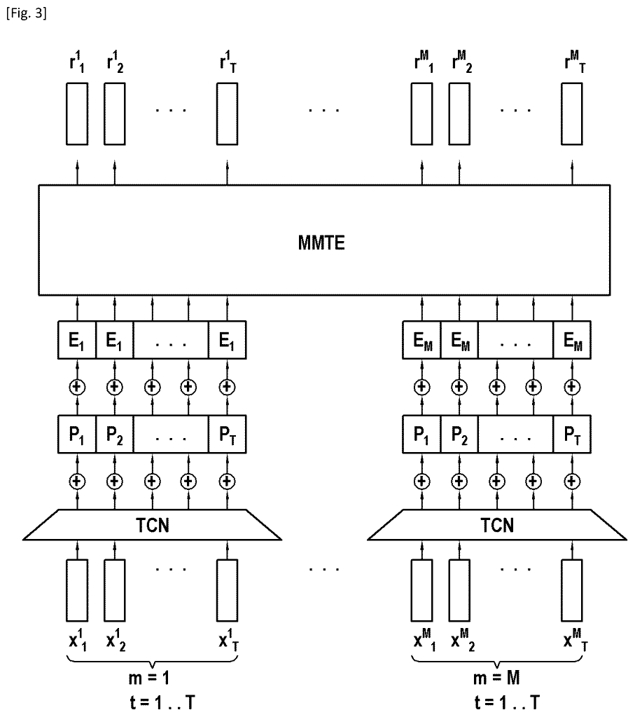

FIG. 3 schematically represents one example of the architecture of an encoder of the assessment model as proposed.

As illustrated in FIG. 3, the encoder takes as input M temporal sequences of input data resulting from sensors fitting an environment and/or a user. Each sequence is associated with a modality m=1 . . . . M, and comprises a series of elements

$${x}_{t = 1 … T}^{m} .$$

Each of these elements

$${x}_{t}^{m}$$

is representative of a state, at one moment t, of the modality m associated with the sequence.

This encoder comprises M temporal convolutional networks (TCNs) that take as input the M temporal sequences of input data. In other words, a temporal convolutional network is dedicated to each of the modalities expected as input to the model. In a manner known per se, each of the M temporal convolutional networks (TCNs) allows extracting T temporal data

$${a}_{t = 1 … T}^{m} .$$

As a variant, the assessment model comprises only a single temporal convolutional network (TCN) that takes as input the M temporal sequences of data.

More formally, let

$${x}_{t}^{m}$$

∈ [symbol] ^{d}^{_{modality}} be an element representative of a state, at one moment t, of the modality m, of dimension d_{modality}. Let

$$[ {x}_{1}^{m} , … , {x}_{T}^{m} ]$$

be the sequence of length T of states associated with the modality m, then:

$$[ {a}_{1}^{m} , … , {a}_{T}^{m} ] = {TCN}^{m} ( [ {x}_{1}^{m} , … , {x}_{T}^{m} ] )$$

with

$${a}_{t}^{m}$$

∈ [symbol] ^{d}^{_{model}} the output sequence of the TCN. For each of the modalities, the outputs have the same size d_{model}.

This encoder further comprises M positional encoding modules taking the form of neural networks (or corresponding to one or more layers of a neural network), each positional encoding module generating T weighted temporal data DPₚ from the T elements

$${x}_{t = 1 … T}^{m} .$$

These weights (or positional encoding data

$$( {P}_{t}^{m} ) )$$

) represent, for each temporal sequence m of input data, the importance of the position of at least one of said elements

$${x}_{t = 1 …T}^{m}$$

in said sequence m.

More formally, for a given modality, let [P₁, . . . , P_{T}] be the sequence of positional encoding data with Pₜ∈ [symbol] ^{d}^{_{model}}, then the output of one of the positional encoding modules is expressed in the form:

$$[ {a}_{1}^{m} + {P}_{1} , … , {a}_{T}^{m} + {P}_{T} ]$$

The encoder further comprises M modal encoding modules also taking the form of a neural network (or corresponding to one or more layers of a neural network), each modal encoding module taking as input the T outputs of one of the positional encoding modules, and generating T weighted temporal data DPₘ. These weights (or modality encoding data)(Eₘ) represent the importance of a modality m among the M modalities of the M temporal sequences of input data.

For each given modality m=1 . . . . M, a modality encoding data Eₘ∈ [symbol] ^{d}^{_{model}} is determined and then added to each input of the associated modal encoding module. The output of this modal encoding module is then expressed in the form:

$$[ {a}_{1}^{1} + {P}_{1} + {E}_{1} , … , {a}_{T}^{M} + {P}_{T} + {E}_{M} ] .$$

More specifically, the elements

$${a}_{t ′}^{m}$$

Pₜ and Eₘ are combined by a combination module, so as to obtain only one sequence of “simple” elements. More formally, let

$${f}_{t}^{m} = {a}_{t}^{m} + {P}_{t} , + {E}_{m} ,$$

and M be the number of modalities expected by the assessment model, then the combined sequence is expressed in the form:

$$[ {f}_{1}^{1} , … , {f}_{T}^{1} , … , {f}_{1}^{M} , … , {f}_{T}^{M} ]$$

The M combined sequences are processed by a multimodal Transformer encoder (MMTE). More specifically, this multimodal Transformer encoder is configured to encode data resulting from a combination, at each moment, of positional encoding data

$${P}_{t}^{m} ,$$

modality encoding data Eₘ and temporal data

$${a}_{t}^{m}$$

determined from the M temporal sequences of input data, so as to obtain M temporal sequences of encoded multimodal representations

$${r}_{t}^{m} .$$

More formally, the encoded representations

$${r}_{t}^{m}$$

at the output of the multimodal Transformer encoder are expressed in the form:

$$[ {r}_{1}^{1} , … , {r}_{T}^{1} , … , {r}_{1}^{M} , … , {r}_{T}^{M} ] = Transformer ( [ {f}_{1}^{1} , … , {f}_{T}^{1} , … , {f}_{1}^{M} , … , {f}_{T}^{M} ] ) .$$

with Transformer ( ) a function implemented by the multimodal Transformer encoder (MMTE).

As is well known, a Transformer encoder comprises a stack of identical encoders that do not share their weights. Each encoder ENCᵢ of the stack is typically divided into two modules:
a self-attention module that constrains the encoder to consider the other elements of the same sequence of input data when it encodes one element in particular (“mono-modal” mode); and,
a module based on a feedforward neural network).

The self-attention module of an encoder ENCᵢ is configured to take as input an element (e.g., a data vector), and generate as output an intermediate representation

$${z}_{i}^{′} ,$$

which is in turn transmitted to the module based on a feedforward neural of this encoder ENCᵢ, so as to generate a representation

$${r}_{i}^{′} .$$

This representation

$${r}_{i}^{′}$$

is then transmitted to the self-attention module of the encoder ENCᵢ₊₁ of the stack that generates as output an intermediate representation

$${z}_{i + 1}^{′} ,$$

which is in turn transmitted to the module based on a feedforward neural network of this encoder ENCᵢ₊₁, so as to generate a representation

$${r}_{i + 1}^{′} .$$

In general, those skilled in the art may refer to the following document for further details regarding the implementation of a multimodal Transformer encoder: “Transformer Encoder With MultiModal Multi-Head Attention for Continuous Affect Recognition”, H. Chen & Al., IEEE Transactions on Multimedia, vol. 23, pp. 4171-4183, 2021.

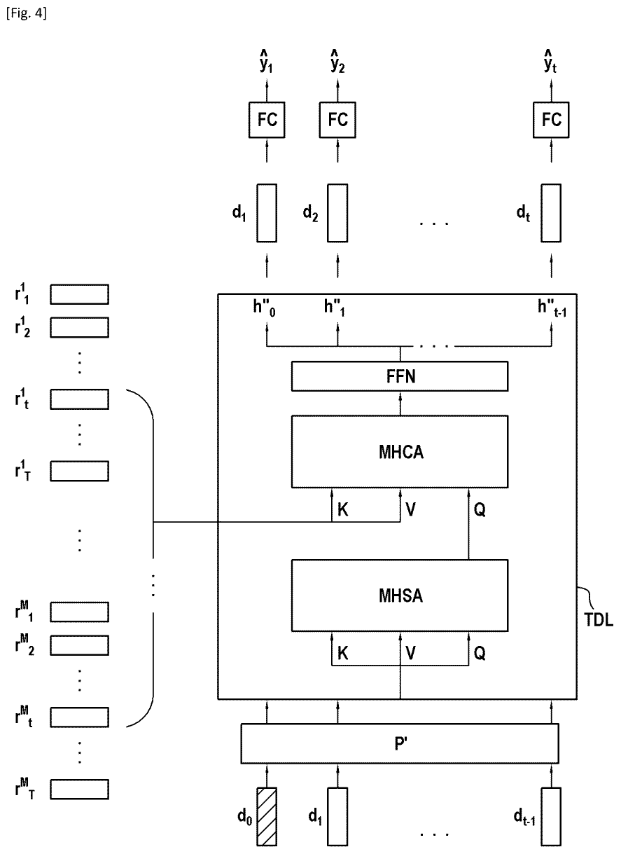

FIG. 4 schematically represents one example of the architecture of a decoder of the assessment model as proposed.

As illustrated in FIG. 4, the decoder of the assessment model as proposed comprises a multimodal Transformer decoder TDL this multimodal Transformer decoder TDL comprising an autoregressive multi-head self-attention MHSA module, a multi-head cross-attention MHCA module, and a first conversion module FFN taking the form of a “fully-connected” neural network.

The MHSA is connected to the MHCA which is itself connected to the FFN. The TDL is itself connected to a second conversion module (FC) taking the form of a layer of a “fully-connected” neural network.

The TDL generates as output a temporal sequence of intermediate assessments [d₁, . . . , dₜ].

The MHSA is said to be autoregressive in the sense that it takes as input the intermediate assessments previously generated by the TDL. More specifically, in the case where the decoder seeks to assess a situation at the current moment t, the MHSA of the TDL takes as input a plurality of intermediate assessments previously generated (d₁, . . . , dₜ₋₁) and having been weighted.

It is important to recall at this point that the use of an autoregressive MHSA is advantageous in that it constrains the assessment model to focus its attention on assessments previously performed by this same model, for a situation that is assumed not evolving abruptly over time.

The decoder further comprises a positional encoding module referenced P′ and taking the form of a neural network (or corresponding to one or more layers of a neural network). This positional encoding module is configured to weight these previously generated intermediate assessments, and operates in a similar manner to those previously mentioned with reference to FIG. 3.

More formally, the multi-head attention mechanism of the MHSA and the MHCA projects a query vector at a first position towards a key vector k at a second position in order to determine the attention (i.e., the weighting) to be given to a value vector v associated with the position of the key vector k. The final value corresponds to the weighted sum of the value vectors v at the different positions. The multi-head attention mechanism is then expressed as follows:
MHA (Q, K, V)
with Q, K and V the sequences used as query, key and value.

In the case where a situation at the moment t is assessed, the TDL has previously generated the sequence [d₁, . . . , dₜ₋₁] with dᵢ∈ [symbol] ^{d}^{_{model}}. The input of the decoder is then expressed as follows:

$$[ {d}_{0} , {d}_{1} , … , {d}_{t - 1} ]$$

With d₀∈ [symbol] ^{d}^{_{model}} a vector initialized using random or predetermined values.

This input is weighted by the positional encoding module P′ which generates the following sequence Iₜ:

$${I}_{t} = [ {d}_{0} + {P}_{0}^{′} , {d}_{1} + {P}_{1}^{′} , … , {d}_{t - 1} + {P}_{t - 1}^{′} ] .$$

Within the TDL, the sequence Iₜ is first processed by the MHSA. It is important at this stage to recall that the MHSA uses a self-attention mechanism aimed at focusing its attention on assessments previously carried out by this same assessment model. Consequently, the query, key and value vectors are all three determined from the input sequence Iₜ. The sequence of features hᵢ∈ [symbol] ^{d}^{_{model}} as output to the MHSA is then expressed in the form:

$$[ {h}_{0} , {h}_{1} , … , {h}_{t - 1} ] = MHA ( {I}_{t} , {I}_{t} , {I}_{t} ) .$$

These feature sequences are then processed by the MHCA module which offers the advantage of constraining the assessment model to focus on the different representations at a certain moment (and consequently on the different modalities processed by the model), without temporal consideration.

More specifically, the MHCA takes as input the sequence of encoded representations

$$[ {r}_{1}^{1} , … , {r}_{T}^{1} , … , {r}_{1}^{M} , … , {r}_{T}^{M} ] .$$

In other words, the key and value vectors are determined from this sequence of encoded representations, and the query vector corresponds to the output of the MHCA. More formally, the output of the MHCA is expressed in the form:

$${H}_{t}^{′} = MHA ( [ {h}_{0} , {h}_{1} , … , {h}_{t - 1} ] , [ {r}_{t}^{1} , … , {r}_{t}^{M} ] , [ {r}_{t}^{1} , … , {r}_{t}^{M} ] ) .$$

Thus, in the case where a situation at the moment t is assessed, the MHCA takes as input the encoded representations associated with this moment t only, so as to constrain the assessment model to focus on the different representations, without temporal consideration.

The TDL further comprises a first conversion module (FFN) taking the form of a fully-connected neural network. Let

$$[ {h}_{0}^{′} , {h}_{1}^{′} , … , {h}_{t - 1}^{′} ] = {H}_{t}^{′} ,$$

with

$${h}_{i}^{′}$$

∈ [symbol] ^{d}^{_{model}}. Then, the temporal sequence of intermediate assessments [d₁, . . . , dₜ] as output to this first conversion module is expressed as follows:

$$[ {h}_{0}^{″} , {h}_{1}^{″} , … , {h}_{t - 1}^{″} ] = [ FFN ( {h}_{0}^{′} ) , FFN ( {h}_{1}^{′} ) , … , FFN ( {h}_{t - 1}^{′} ) ] .$$

$$and$$

$${d}_{i} = {h}_{i - 1}^{″} with i ∈ [ 1 , t ] .$$

The invention has so far been described in the case where the decoder comprises only one TDL. These developments can however be generalized without difficulty by those skilled in the art to the case where the decoder comprises a stack of TDLs. In this particular case, the developments previously mentioned apply to the first TDL (to be entered in the stack), and the sequence

$$[ {h}_{0}^{″} , {h}_{1}^{″} , … , {h}_{t - 1}^{″} ]$$

corresponds to the input of the second TDL (to be entered in the stack). The last TDL (to be entered in the stack) determines the sequence of intermediate data [d₁, . . . , dₜ] such that

$${d}_{i} = {h}_{t - 1}^{″}$$

with i∈[1, t].

The decoder further comprises the second conversion module (FC) which takes as input this sequence [d₁, . . . , dₜ], and converts each element of the sequence into a value representative of a situation (or into a value vector representative of one or more different situations), so as to obtain a temporal sequence where each element corresponds, at a certain moment, to an assessment of a particular situation. As mentioned previously, this second conversion module takes the form of a layer of a “fully-connected” neural network applied to each of the elements of the sequence [d₁, . . . , dₜ].

In one particular mode of implementation, the same second conversion module is applied to each element.

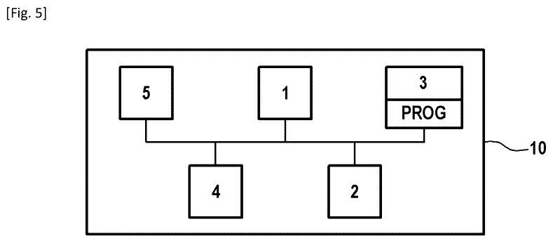

FIG. 5 schematically represents one example of hardware architecture of an electronic assessment device (10) as proposed.

As illustrated in FIG. 5, the electronic assessment device 10 has the hardware architecture of a computer. Thus, the electronic assessment device 10 includes, in particular, a processor 1, a random access memory 2, a read-only memory 3 and a non-volatile memory 4. It further includes a communication module 5.

The read-only memory 3 of the wireless communication device 10 constitutes a recording medium as proposed, readable by the processor 1 and on which a computer program PROG in accordance with the invention is recorded, including instructions for executing steps of the generation method as proposed below. The program PROG defines one or more functional modules of the electronic assessment device, which rely on or control the hardware elements 1 to 5 mentioned above, and which comprise in particular:
a module for obtaining a plurality (M) of temporal sequences of input data resulting from sensors fitting an environment and/or a user, each sequence being associated with a modality (m), each element

$$( {x}_{t}^{m} )$$

of a sequence being representative of a state, at one moment (t), of the modality (m) associated with the sequence;
a multimodal Transformer encoder (MMTE) configured to encode data resulting from a combination, at each moment, of positional encoding data

$$( {P}_{{t}^{′}}^{m} ) ,$$

modality encoding data (Eₘ) and temporal data determined from the plurality (M) of temporal sequences of input data, so as to obtain a plurality (M) of temporal sequences of encoded multimodal representations

$$( {r}_{t}^{m} ) ;$$

a multimodal Transformer decoder (TDL) configured to generate a temporal sequence of intermediate assessments (dₜ), the multimodal decoder comprising an autoregressive multi-head self-attention (MHSA) sub-module; and a multi-head cross-attention (MHCA) sub-module taking as input the plurality (N_{RM}) of temporal sequences of encoded multimodal representations

$$( {r}_{t}^{m} ) ;$$

a module (FC) for converting the temporal sequence of intermediate assessments into the temporal sequence of assessments of a situation; and,
a module (not represented) for controlling a triggering of a service adapted to the environment and/or to the user, as a function of the temporal sequence of assessments of a situation.

Moreover, the wireless communication device 10 may also include other modules, in particular to implement particular modes of the full-duplex communication method, as described in more detail later.

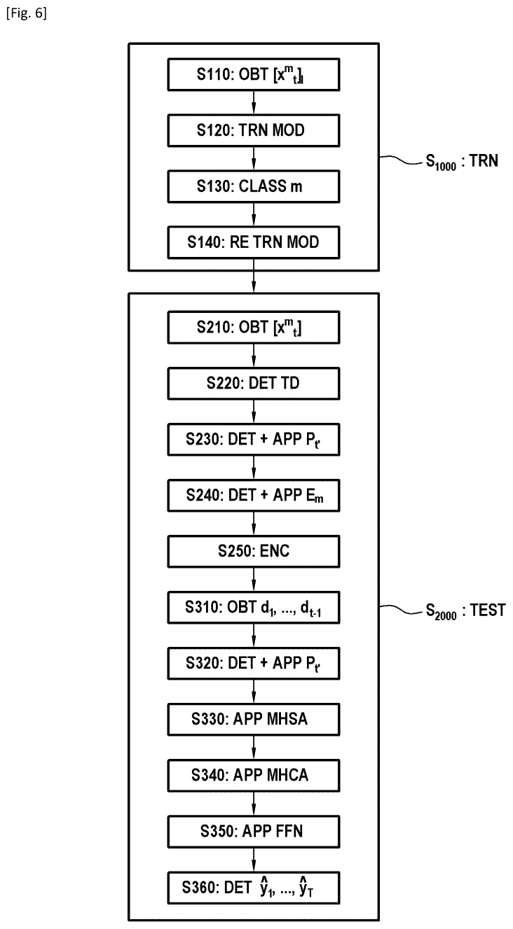

FIG. 6 illustrates, in the form of a flowchart, the main steps of a general method for assessing a situation, according to one exemplary implementation of the invention.

As illustrated in FIG. 6, the general method for assessing a situation comprises a first phase S1000 of training an assessment model comprising the steps S110 to S140, and a second phase S2000 of validating or exploiting the assessment model and comprising the steps S210 to S360, this second phase corresponding to one example of a generation method as proposed.

### Training Phase S1000

The method comprises a first step S110 of obtaining a plurality (M) of temporal sequences of labeled training data, each sequence being associated with a modality m, each element

$${x}_{t}^{m}$$

of a sequence being representative of a state, at one moment t, of the modality m associated with the sequence. This step S110 is implemented by the aforementioned module for obtaining a plurality of temporal sequences.

More concretely, these learning data are provided as input to the model in the form of data vectors.

In one particular exemplary implementation, raw data emitted by different types of sensors—each sensor being associated with a particular modality—are continuously recorded in a database. The samples of these raw data are labeled using a value representative of one or more categories or classes. This representative value is for example comprised in the interval [−1;1].

In one particular exemplary implementation, signals associated with a visual modality (and corresponding for example to image sequences captured by an image capture device such as a camera or a still camera), an audio modality (and corresponding for example to sound samples captured by a microphone), and a physiological modality (and corresponding for example to signals representative of respiratory rate, heart rate and/or electric brain activity captured by a smartwatch) are considered.

In one particular exemplary implementation, the assessment model is a model for assessing an emotional state, and fifteen classes of emotions are defined: neutral (1), disgusted (2), panicked (3), anxious (4), angry (5), cold anger (6), desperate (7), sad (8), enthusiastic (9), happy (10), interested (11), bored (12), ashamed (13), proud (14), and contemptuous (15). The classes disgusted (2), panicked (3), anxious (4), angry (5), cold anger (6), desperate (7), sad (8), bored (12), and ashamed (13) can be considered negative and the emotion classes enthusiastic (9), happy (10), and interested (11) can be considered positive.

This database is accessible by a raw data analysis module, for example embedded in the electronic assessment device 10, and which is then configured to generate new signals based on the raw data. This analysis module is also configured to segment the raw data into data segments of a predetermined time interval (for example 30 seconds), without overlapping the segments.

The temporal segmentation allows having chronologically synchronized time series of interest. For example, a temporal segmentation into 30-second time intervals has the effect that all the time series of interest include, for each 30-second time interval, an associated value of a quantity of interest. This temporal synchronization allows for example establishing multimodal correlations between the values of different quantities of interest during the same time interval, or during consecutive time intervals. Thus, it is possible to structure in the model, for example, a correlation between the user's speech rate during a given time interval and a facial expression during a following time interval.

Then, the analysis module identifies features of interest (e.g., a face, words of the individual, etc.) from the raw data, and generates signals of interest. These signals of interest are finally processed by the analysis module so as to generate learning data that will be used during the training phase S1000 of the assessment model.

This processing generally allows shaping the signals of interest for the purpose of assessing the situation (e.g., the emotional state of the person).

In one particular exemplary implementation, the targeted processing includes the calculation of the facial features (Facial Action Units), of the sound features eGeMAPS (extended Geneva Minimalistic Acoustic Parameter Set), and/or a concatenation of BPM (Beat Per Minutes) data, of an electrocardiogram and of a respiratory rate.

In one particular exemplary implementation, the targeted processing includes at least one among: the application of a low-pass filtering, a normalization, or a resampling. The low-pass filtering offers the advantage of denoising the information, the normalization allows standardizing the data and the resampling of data allows synchronizing the sources.

The training phase further comprises a step S120 during which the assessment model is trained, by processing the learning data obtained during step S110.

In one particular mode of implementation, the assessment model is trained by application of a cost function defined such that [symbol] =1−CCC with CCC being the concordance correlation coefficient.

It is recalled at this stage that the concordance correlation coefficient is expressed in the form:

$$CCC = \frac{2 ρ {σ}_{\hat{y}} {σ}_{y}}{{σ}_{\hat{y}}^{2} + {σ}_{y}^{2} + {( {μ}_{\hat{y}} - {μ}_{y} )}^{2}} ,$$

with ρ the correlation coefficient between the predicted values ŷ and the exact values (ground-truth values), σ the standard deviation and μ the mean of either the predicted values or the exact values.

In one particular mode of implementation, the phase S1000 further comprises the steps S130 and S140. During step S130, the modality(ies) having a significant impact on the assessment of a given situation are identified. To do so, the assessment model is first trained by application of the step S120, then this same assessment model, once trained, is assessed by processing data from a single modality at a time. In other words, this assessment model assesses the same situation iteratively, considering at each iteration input data resulting from the same modality.

Then the iterations during which the performance of the assessment is low (e.g., the lowest or, as a variant, those below a predetermined threshold value) are determined, which correspond to the modalities having a significant impact on the assessment performance of the model. In this way, each of the modalities is classified according to its impact on the performance of the prediction model.

The training phase S1000 then comprises a step S140 during which the assessment model is re-trained, but this time by excluding, from the input data, those associated with the modalities determined during step S130 as having a significant impact on the assessment performance.

According to one particular example, for each sequence of input data, the data associated with the modalities having a significant impact with a probability pₑₗᵢₘᵢₙₐₜₑ are excluded from the relearning, with pₑₗᵢₘᵢₙₐₜₑ a probability that the data is missing or present, and only the modalities having a probability pₙₒₙₑ=1−pₑₗᵢₘᵢₙₐₜₑ are considered as input to the assessment model during this step S140.

Thus, by hiding from the assessment model the modalities having a significant impact on the performance, this constrains this model to assess the correlations between the modalities having a less significant impact. Thus, these steps S130 and S140 allow obtaining a model for assessing a situation that is more robust in the event of missing data for at least one of the modalities classically expected as input to the assessment model, and having a significant impact on performance.

### Phase S2000 of Validating or Exploiting the Previously Trained Model

This phase S2000 corresponds to a method for generating a temporal sequence of assessments (or predictions) of a situation by an assessment model (based on a neural network) that is robust in the event of missing input data.

The phase S2000 comprises the steps S210 to S250 implemented by the encoder as represented in FIG. 3, and the steps S310 to S360 implemented by the decoder as represented in FIG. 4.

As illustrated in FIG. 6, the method for generating a sequence comprises a first step of obtaining input data from a plurality (M) of temporal sequences of input data resulting from sensors fitting an environment and/or a user, each sequence being associated with a modality (m), each element

$$( {x}_{t}^{m} )$$

of a sequence being representative of a state, at one moment (t), of the modality (m) associated with the sequence.

The step of obtaining these input data is similar to step S110, and is not re-detailed for the sake of brevity. Since it is a validation or exploitation phase, this step S210 is distinguished from step S110 by the fact that the input data are of course not labeled. This step is implemented by the aforementioned module for obtaining a plurality of temporal sequences.

The method for generating a sequence further comprises a step S220 during which temporal data are determined by application of at least the temporal convolutional network TCN of the encoder to the plurality (M) of temporal sequences of input data.

During a step S230, positional encoding data

$$( {P}_{t}^{m} )$$

are determined by one or more of the positional encoding modules of the encoder, these encoding data representing, for each temporal sequence of input data, the importance of the position of at least one of said elements in said sequence. The positional encoding data are then combined with the temporal data, so that the output of this positional encoding module is then expressed for example in the form:

$$[ {a}_{1}^{m} + {P}_{1} , … , {a}_{T}^{m} + {P}_{T} ] .$$

Then, during a step S240, modal encoding data (Eₘ) are determined by the modal encoding module of the encoder, these encoding data representing, for each temporal sequence of input data, the importance of a modality among the M modalities of the input data. The modal encoding data are then combined with the outputs of the positional encoding module of the encoder, so that the output of this modal encoding module is then expressed for example in the form:

$$[ {a}_{1}^{m} + {P}_{1} + {E}_{m} , … , {a}_{T}^{m} + {P}_{T} + {E}_{m} ] .$$

The method further comprises a step S250 of encoding, according to a multimodal Transformer encoding model, the output

$$[ {a}_{1}^{m} + {P}_{1} + {E}_{m} , … , {a}_{T}^{m} + {P}_{T} + {E}_{m} ] ,$$

so as to obtain a plurality (M) of temporal sequences of encoded multimodal representations

$$( {r}_{t}^{m} ) .$$

This step is implemented by the multimodal Transformer encoder MMTE mentioned above.

In one particular mode of implementation, the encoding step S250 comprises a sub-step of filtering the input data of the multimodal Transformer encoding model, so as to encode only the data comprised in a sliding time window relative to a current moment t.

Then, during a step S310, the decoder obtains as input the intermediate assessments previously generated by the TDL. Thus, in the case where the decoder seeks to assess a situation at the moment t, the MHSA of the TDL takes as input a plurality (e.g., t−2) of intermediate assessments previously generated ([d₁, . . . , dₜ₋₁]) and having been weighted.

The generation method further comprises a step S320 during which positional encoding data

$$( {P}_{t}^{′} )$$

are determined by a positional encoding module (P′) of the decoder. The positional encoding data are then combined with the plurality of previously generated intermediate assessments, so that when assessing the situation at the moment t, the input Iₜ of the multimodal Transformer decoder is expressed for example in the form:

$${I}_{t} = [ {d}_{0} + {P}_{0}^{′} , … , {d}_{t - 1} + {P}_{t - 1}^{′} ]$$

The generation method further comprises a step S330 during which a self-attention mechanism is applied to the input Iₜ by the MHSA.

It is important to recall at this stage that the application of a self-attention mechanism offers the advantage of constraining the assessment model to focus its attention on assessments previously performed by this same assessment model.

The generation method further comprises a step S340 during which a cross-attention mechanism is applied by the MHCA. It is important to recall at this stage that the application of a cross-attention mechanism offers the advantage of constraining the assessment model to focus on the different representations at a certain moment (and consequently on the different modalities processed by the model), without temporal consideration. The output of the MHCA is expressed in the form:

$${H}_{t}^{′} = MHA ( [ {h}_{0} , {h}_{1} , … , {h}_{t - 1} ] , [ {r}_{t}^{1} , … , {r}_{t}^{M} ] , [ {r}_{t}^{1} , … , {r}_{t}^{M} ] ) .$$

The generation method further comprises a step S350 during which the first conversion module FFN generates the temporal sequence of intermediate assessments [d₁, . . . , dₜ] such that:

$$[ {h}_{0}^{″} , {h}_{1}^{″} , … , {h}_{t - 1}^{″} ] = [ FFN ( {h}_{0}^{′} ) , FFN ( {h}_{1}^{′} ) , … , FFN ( {h}_{t - 1}^{′} ) ] .$$

$$and {d}_{i} = {h}_{i - 1}^{″} with i ∈ [ 1 , t ] .$$

Then, during a step S360, each element of this sequence [d₁, . . . , dₜ] is converted into a value representative of a situation (or into a value vector representative of one or more different situations), so as to obtain a temporal sequence [ [symbol] , . . . , ŷₜ] where each element corresponds, at a certain moment, to an assessment of a particular situation.

The invention has so far been described in the case where the decoder comprises only a single TDL. However, these developments can be easily generalized by those skilled in the art to the case where the decoder comprises a stack of TDLs. In this particular case, steps S330, S340, and S350 are repeated.

Finally, this situation assessment temporal sequence [ [symbol] , . . . , ŷₜ] is used to determine whether or not a service adapted to the environment and/or to the user should be triggered.

To this end, according to one particular exemplary implementation, a plurality of digital services that can be suggested to a person and defined by respective links are stored in a correspondence table, in association with respective score thresholds. If a threshold is exceeded by one or more elements of the temporal sequence [ [symbol] , . . . , ŷₜ], at least one link of a corresponding digital service is read to suggest said corresponding digital service to the user via a human-machine interface. The assessed situation corresponds for example to the emotional state of the person.

Thus, a service is only recommended to the person if the intensity of an assessment of a predetermined situation is sufficiently high. This has the effect of reserving the suggestion of services to this person at the moments when the execution of these services would be most useful to them.

According to one particular exemplary implementation, an animation routine of a human-machine interface of any communicating equipment in the environment in which a person is located (e.g., a connected home) is triggered.

The service recommendation is for example executed on the best broadcast channel for the person, such as the living room TV, a communicating speaker, a Smartphone, etc. The most suitable communicating equipment for this purpose can be selected for example based on the functionalities offered by the various communicating equipment in the installation.

Another criterion may be a distance estimation, at the current moment, between the various communicating equipment and the person, making it possible to choose, among the various communicating equipment in the installation able to trigger the proposed services, the one closest to the person at the current moment.

According to a non-limiting example, the assessed situation corresponds to an assessment of the emotional state of a person, and the animation routine is configured to suggest to the person at least one predefined digital service associated with the assessment of their emotional state. For example, if the predicted situation is “panicked”, the associated services in a preference model may be, in order of preference, “an incentive to call a friend”, “an incentive to call the remote assistance service”, or “an increase in home comfort through the automatic adjustment of the brightness”.

Other examples of services may be described for each “negative” emotional situation according to the preferences and habits of the individuals. These preferences may be defined by the individuals themselves or by a trusted third party, such as family, a close friend, or the medical profession. These preferences may be defined, reorganized, or updated automatically by learning from the services used in the past, in correlation with the assessed situations.

The invention has so far been described in the case where the combination operator “+” corresponds to an addition. The invention nevertheless remains applicable in the case where other combination operators are considered, such as “×”.

1. A generation method for generating a temporal sequence of assessments of a situation by a robust assessment model in an event of missing input data, the method being implemented by an electronic device and comprising:
obtaining a plurality of temporal sequences of input data resulting from sensors fitting an environment and/or a user, each sequence being associated with a modality, each element of a sequence being representative of a state, at one moment, of the modality associated with the sequence;
encoding, according to a multimodal Transformer encoding model, data resulting from a combination, at each moment, of positional encoding data, modality encoding data and temporal data determined from the plurality of temporal sequences of input data, so as to obtain a plurality of temporal sequences of encoded multimodal representations;
decoding, comprising applying an autoregressive self-attention model; and implementing a cross-attention model taking as input the plurality of temporal sequences of encoded multimodal representations, to generate a temporal sequence of intermediate assessments; and,
converting the temporal sequence of intermediate assessments into the temporal sequence of assessments of a situation, said temporal sequence of assessments of a situation making it possible to control a triggering of a service adapted to the environment and/or to the user.

2. The generation method of claim 1, the self-attention model being autoregressive in that, at a current moment t, said self-attention model takes as input the intermediate assessments d_{t′=1 . . . t-1} previously determined by said assessment model from input data associated with past moments t′=1 . . . t−1.

3. The generation method of claim 1, wherein the positional encoding data represent, for each temporal sequence of input data, the importance of the position of at least one of said elements in said sequence.

4. The generation method of claim 1, wherein the modality encoding data represent the importance of a modality among the modalities of the plurality of temporal sequences of input data.

5. The generation method of claim 1, further comprising determining the temporal data by application of at least one temporal convolutional network to the plurality of temporal sequences of input data.

6. The generation method of claim 1, wherein the encoding comprises filtering the data as input to the multimodal Transformer encoding model, to encode only the data comprised in a sliding time window relative to a current moment t.

7. The generation method according to any of claims-claim 1, further comprising determining positional encoding data, and combining the intermediate assessments d_{t′=1 . . . t-1} previously determined by said assessment model from input data associated with moments t′=1 . . . t−1 with the determined positional encoding data, to obtain the intermediate assessments.

8. The generation method of claim 1, wherein the cross-attention model takes as input M encoded representations
$${r}_{t}^{m = 1 … M}$$
associated with a current moment t, with M the number of temporal sequences of input data.

9. The generation method of claim 1, further comprising:
obtaining a plurality of temporal sequences of labeled learning data, each sequence being associated with a modality, each element of a sequence being representative of a state, at one moment, of the modality associated with the sequence;
training the assessment model by minimizing a cost function defined such that [symbol] =1−CCC with CCC being a concordance correlation coefficient.

10. The generation method of claim 9, further comprising:
iteratively generating assessments of the situation, by the assessment model, by processing input data of the same modality at each iteration, so as to classify the modalities according to their impact on the performance of the assessment model;
retraining the assessment model, by taking as input learning data whose modality has an impact on the performance of the assessment model below a predetermined threshold.

11. The generation method of claim 1, wherein the situation corresponds to an emotional state of a user.

12. The generation method of claim 1, wherein:
the sensors comprise a sound capture device and the associated temporal sequence of input data comprises elements representative of words issued by the user and/or of the user's prosody; and/or
the sensors comprise a physiological sensor, and the associated temporal sequence of input data comprises elements representative of the user's heart rate, respiratory rate and/or electric brain activity;
the sensors comprise an image capture device, and the associated temporal sequence of input data comprises elements representative of the user's facial and/or body expression.

13. A non-transitory recording medium comprising a computer program stored thereon including instructions for implementing the generation method according to claim 1, when said program is executed by a computer.

14. (canceled)

15. An electronic device comprising:
at least one processor; and
at least one non-transitory computer readable medium comprising instructions stored thereon which when executed by the at least one processor configure the electronic device to determine a temporal sequence of assessments of a situation by an assessment model which is, robust in the event of missing input data, the determining comprising:
obtaining a plurality of temporal sequences of input data resulting from sensors fitting an environment and/or a user, each sequence being associated with a modality, each element of a sequence being representative of a state, at one moment, of the modality associated with the sequence;
encoding, by a multimodal Transformer encoder, to encode data resulting from a combination, at each moment, of positional encoding data, modality encoding data and temporal data determined from the plurality of temporal sequences of input data, so as to obtain a plurality of temporal sequences of encoded multimodal representations
$$( {r}_{t}^{m} ) ;$$
decoding, by a multimodal Transformer decoder, to generate a temporal sequence of intermediate assessments, the multimodal decoder applying an autoregressive multi-head self-attention model; and a multi-head cross-attention model taking as input the plurality of temporal sequences of encoded multimodal representations;
converting the temporal sequence of intermediate assessments into the temporal sequence of assessments of a situation; and,
controlling a triggering of a service adapted to the environment and/or to the user, according to the temporal sequence of assessments of a situation.
